(19) United States
(12) Patent Application Publication
(10) Pub. No.: US 2026/0157371 A1
(43) Pub. Date: Jun. 11, 2026

(54) AGROCHEMICALLY ACTIVE SUBSTITUTED MORPHOLINE SALTS OF WEAK ACID HERBICIDES

(71) Applicant: pHocas LLC, Sugar Land, TX (US)

(72) Inventors: R. Scott Tann, Sugar Land, TX (US); Stephen L. Sloan, Lincoln, IL (US); Matthew T. Meredith, Spring, TX (US)

(21) Appl. No.: 19/411,885

(22) Filed: Dec. 8, 2025

Related U.S. Application Data
(60) Provisional application No. 63/729,098, filed on Dec. 6, 2024.

(51) Int. Cl. A01N 43/84; A01N 37/38; A01P 13/00

(52) U.S. Cl. CPC A01N 43/84; A01N 37/38; A01P 13/00

(57) ABSTRACT

The present disclosure provides improved herbicidal effectiveness, low vapor and/or particle drift potential, and improved rain fastness compared to dimethylamine salt, ester forms, and choline salt formulations of the phenoxy herbicide or other conventional formulations. In some embodiments, an agrochemical composition includes a substituted morpholine salt of a phenoxy herbicide, such as an auxin herbicide. The substituted morpholine may be hydroxyethyl morpholine (HEM) derived from a reaction of morpholine and an alkylene oxide or ethylene oxide. The composition may further include additional active ingredients for weed control, agriculturally acceptable adjuvants or carriers, or other constituents.

### CROSS-REFERENCE TO RELATED APPLICATIONS

This application claims priority to U.S. Provisional Application No. 63/729,098, titled “AGROCHEMICALLY ACTIVE SUBSTITUTED MORPHOLINE SALTS OF WEAK ACID HERBICIDES,” filed Dec. 6, 2024, the entirety of which is incorporated by reference herein.

### TECHNICAL FIELD

The present disclosure relates to agrochemically active compounds, and more particularly to substituted morpholine salts of weak acid herbicides.

### BACKGROUND

Herbicide salts are commonly used in modern agriculture, offering improved efficiency and ease of application compared to their acid counterparts. These formulations are widely used for weed control in various crops, helping to increase yields and reduce labor costs associated with manual weed removal. Among the diverse array of herbicide salts, those derived from 2,4-dichlorophenoxyacetic acid (2,4-D) have gained particular prominence due to their broad-spectrum activity against dicotyledonous weeds. Herbicide salts including 2,4-D, such as dimethylamine and choline formulations, are valued for their selective action in many crops, systemic properties that allow translocation throughout target plants, and relatively low soil persistence. However, challenges remain in optimizing the balance between herbicidal effectiveness, crop safety, and environmental impact for these and other weak acid herbicide salts.

### SUMMARY

In some examples, the disclosure describes an agrochemical composition that includes a substituted morpholine salt of a phenoxy herbicide, such as an auxin herbicide. This composition provides an effective herbicide with improved properties compared to other herbicide salt formulations. The substituted morpholine may be hydroxyethyl morpholine (HEM), which can be derived from a reaction of morpholine and an alkylene oxide or ethylene oxide. The auxin herbicide may include compounds such as (4-chloro-2-methylphenoxy)acetic acid (MCPA); 2,4-dichlorophenoxyacetic acid (2,4-D); 2,4,5-trichlorophenoxyacetic acid (2,4,5-T); mecoprop; dichlorprop; fenoprop; 4-(2,4-dichlorophenoxy)butyric acid (2,4-DB); 4-(4-chloro-2-methylphenoxy)butyric acid (MCPB), and triclopyr. This composition demonstrates high herbicidal effectiveness and low vapor and/or particle drift potential compared to dimethylamine salt, ester forms, and choline salt of the phenoxy herbicide. It may also enhance uptake, improve droplet distribution, reduce volatility, and ensure compatibility with other herbicides and formulation components. The agrochemical composition may be substantially odorless, maintain herbicidal activity for at least 7 days after application, and demonstrate rain fastness. Optionally, the agrochemical composition may include additional active ingredients for weed control and an agriculturally acceptable adjuvant or carrier.

In some examples, the disclosure describes a method of preparing this agrochemically active composition. The method includes forming a salt of a substituted morpholine with a phenoxy herbicide. The method may include reacting morpholine with an alkylene oxide or ethylene oxide to form the substituted morpholine. Additionally, the method may include combining the salt with an agriculturally acceptable adjuvant or carrier.

In some examples, the disclosure describes a method of controlling weeds that includes applying this agrochemical composition to a crop or directly to a target plant or other pest. The composition can be applied as an herbicide and demonstrates high herbicidal effectiveness, low vapor and/or particle drift potential, and rain fastness compared to other salt forms of the phenoxy herbicide.

### BRIEF DESCRIPTION OF FIGURES

Non-limiting and non-exhaustive examples are described with reference to the following figures.

FIG. 1 is a bar graph illustrating experimental results comparing percent control of broadleaf signal for nine experimental treatments.

FIG. 2 is a bar graph illustrating experimental results comparing percent control of ivyleaf morning glory for the nine treatments.

FIG. 3 is a bar graph illustrating experimental results comparing percentage of injury to Border Row 1 of soybeans for the nine treatments.

FIG. 4 is a bar graph illustrating experimental results comparing percentage of injury to Border Row 2 of soybeans for the nine treatments.

FIG. 5 is a bar graph illustrating experimental results comparing percentage of injury to Border Row 3 of soybeans for the nine treatments.

FIG. 6 is a bar graph illustrating experimental results comparing percentage of injury to Border Row 4 of soybeans for the nine treatments.

FIG. 7 is a graph illustrating pH titration curves comparing neutralization behavior of 2,4-D with diglycolamine (DGA) and hydroxyethyl morpholine (HEM) as a function of amine to 2,4-D molar ratio.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The present disclosure relates to agrochemical compositions including substituted morpholine salts of weak acid herbicides. Example weak acid herbicides may include phenoxy herbicides and organophosphate herbicides. The described agrochemical compositions may provide several advantages over existing herbicide formulations, particularly for auxin herbicides. For example, the described agrochemical compositions demonstrate high herbicidal effectiveness while exhibiting low vapor and particle drift potential. This combination of properties may address longstanding challenges associated with traditional herbicide formulations such as dimethylamine salts, ester forms, and choline salts (also referred to as quaternary salts or quats) of phenoxy herbicides.

Additionally, the example compositions described herein may offer improved performance characteristics compared to formulations that do not include substituted morpholine salts of phenoxy herbicides. For example, the substituted morpholine salts may provide increased uptake by unwanted plants, weeds, or other pests (referred to herein as, target plants), improved droplet distribution when sprayed, reduced volatility or degradation after application, improved adjuvant effect, improved effectiveness over a broad range of geographic regions, and enhanced compatibility with other herbicides and formulation components. These properties may contribute to more effective weed control.

In some examples, the agrochemical compositions exhibit rain fastness, allowing the herbicide to remain effective even after rainfall. For example, droplet dry down may result in a salt, which remains mobile into the target plant during subsequent wetting. In contrast, the constituents of other herbicide salts may dry down, solidify, leaving only the herbicide acid, which is no longer mobile into the target plant. Furthermore, other herbicide salts can volatilize and drift to cause injury to other desirable vegetation. The reduction of volatility and slowing droplet dry down may extend the window of application and reduce the need for repeated treatments, particularly when considering environmental conditions such as temperature, rain forecast, wind speeds, or the like.

Another potential advantage of the disclosed agrochemical compositions is reduced odor. In some implementations, the substituted morpholine salts of phenoxy herbicides may be substantially odorless, addressing concerns related to strong odors associated with certain conventional herbicide formulations. For example, the reduced volatility and degradation of the substituted morpholine may contribute to reduced odor during and after application to a target plant compared to constituents of other herbicide salts that do not contain substituted morpholine. As such, the described agrochemical compositions may be more desirable for application in residential or commercial areas where odor may be offensive to persons near the application area.

The combination of advantages may make the described agrochemical compositions particularly suitable for a wide range of agricultural, commercial, and residential applications. The disclosed agrochemical formulations aim to provide improved tools for weed management while potentially mitigating some of the drawbacks associated with existing herbicide products.

Morpholine is a chemical compound with low molecular weight, which has been used in many commercial applications. The basic structure of morpholine is that of a six-atom heterocyclic ring composed of an oxygen atom and a nitrogen atom at opposite ends of the heterocyclic ring. The nitrogen atom and oxygen atom are separated by two carbon atoms. The nitrogen atom of the morpholine structure may be converted into a tertiary nitrogen atom by the addition of an alkyl group such as a methyl, ethyl, propyl (isopropyl or n-propyl) or butyl groups (isobutyl, sec-butyl, tert-butyl, n-butyl) groups. The alkyl substitutions could potentially contain unsaturated carbon chains. Additionally, the nitrogen atom can be reacted with ethylene oxide, propylene oxide, or butylene oxide to create alkyl structures attached to the nitrogen atom that further possess a hydroxyl group. The nitrogen atom of morpholine can be reacted to form an amide structure such as that of N-formyl morpholine, N-acetyl morpholine, N-propyl morpholine, and other 3- or 4-carbon structures in which the nitrogen atom of the amide is contributed by morpholine.

In some examples, agrochemical compositions disclosed herein include a substituted morpholine including hydroxyethyl morpholine (HEM). HEM may be derived from a reaction of morpholine and an alkylene oxide or ethylene oxide. For example, HEM may be produced by reacting morpholine with ethylene oxide in an equimolar ratio.

In some examples, the phenoxy herbicide includes an auxin herbicide. The auxin herbicide may include at least one of (4-chloro-2-methylphenoxy)acetic acid (MCPA), 2,4-dichlorophenoxyacetic acid (also referred to as “2,4-D”); 2,4,5-trichlorophenoxyacetic acid (also referred to as “2,4,5-T”); (RS)-2-(4-chloro-2-methylphenoxy)propanoic acid (also referred to as “mecoprop”), (R)-2-(2,4-dichlorophenoxy)propanoic acid (also referred to as “dichlorprop” or “2,4-DP”), rac-(2R)-2-(2,4,5-trichlorophenoxy)propanoic acid (also referred to as “fenoprop”), 4-(2,4-dichlorophenoxy)butyric acid (also referred to as “2,4-DB”), and 4-(4-chloro-2-methylphenoxy)butyric acid (also referred to as “MCPB”). Additionally, or alternatively, the phenoxy herbicide may include pyridine carboxylate Group 4 herbicides, such as aminopyralid, clopyralid, florpyrauxifen, fluroxypyr, halauxifen, quinclorac, and triclopyr.

In other examples, phenoxy herbicides and salts thereof may include the herbicides or salts thereof described in U.S. Pat. No. 10,334,849, filed Oct. 26, 2012, entitled “Salts of Carboxylic Acid Herbicides;” U.S. Pat. No. 8,912,120, filed Mar. 15, 2013, entitled “Herbicidal Compositions Comprising 4-amino-3-chloro-5-fluoro-6-(4-chloro-2-fluoro-3-methoxyphenyl) pyridine-2-carboxylic acid or a Cerivative Thereof and Synthetic Auxin Herbicides;” and U.S. Pat. No. 9,167,810, filed Feb. 26, 2008, entitled “Compounds Derived from Herbicidal Carboxylic Acids and Tetraalkylammonium or (Arylalkyl) Trialkylammonium Hydroxides;” as well as U.S. Patent Application Publication Nos.: 2019/0116788, filed Oct. 16, 2018, entitled “Dicamba Compositions with Reduced Spray Drift Potential;” and 2014/0073505, filed Sep. 11, 2013, entitled “Herbicidal Compositions Comprising Aminopyralid and Triclopyr;” the entirety of each of which is incorporated by reference herein.

In some examples, the described agrochemical compositions may be compatible with other herbicides and formulation components. For example, the described agrochemical compositions may be used in the preparation of formulations further including one or more additional co-herbicides. Co-herbicides include carboxylic acid herbicides and salts thereof (e.g., auxin herbicide salts as previously described). Co-herbicides also include acetyl-CoA carboxylase (ACCase) inhibitors; acetolactate synthase (ALS), also known as acetohydroxy acid synthase (AHAS) inhibitors; photosystem II inhibitors, photosystem I inhibitors; protoporphyrinogen oxidase (PPO or Protox) inhibitors; carotenoid biosynthesis inhibitors; enolpyruvyl shikimate-3-phosphate (EPSP) synthase inhibitor; glutamine synthetase inhibitor; dihydropteroate synthetase inhibitor; mitosis inhibitors; 4-hydroxyphenyl-pyruvate-dioxygenase (4-HPPD) inhibitors; synthetic auxins; auxin transport inhibitors and nucleic acid inhibitors; salts and esters thereof; racemic mixtures and resolved isomers thereof; and combinations thereof. Specific examples of possible co-herbicides include aminocyclopyrachlor; mecoprop-P; triclopyr; acetochlor; acifluorfen; alachlor; atrazine; azafenidin; bifenox; butachlor; butafenacil; carfentrazone-ethyl; diuron, dithiopyr; flufenpyr-ethyl; flumiclorac-pentyl; flumioxazin; fluoroglycofen; fluthiacet-methyl; fomesafen; glyphosate; glufosinate; imazethapyr; lactofen; metazochlor; metolachlor (and S-metolachlor); metribuzin; oxadiargyl; oxadiazon; oxyfluorfen; pretilachlor; propachlor; propisochlor; pyraflufen-ethyl; sulfentrazone; thenylchlor; salts and esters thereof; racemic mixtures and resolved isomers thereof, and combinations thereof. In some examples, the co-herbicide is a photosystem II inhibitor selected from, for example, ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine, trietazine, salts and esters thereof, and mixtures thereof. In other examples, the co-herbicide is a 4-HPPD inhibitor selected from, for example, mesotrione, isoxaflutole, benzofenap, pyrazolynate, pyrazoxyfen, sulcotrione, tembotrione, and tropramezone. In accordance with another example, the co-herbicide is a graminicide selected from butroxydim, clethodim, cycloxydim, sethoxydim, tepraloxydim, tralkoxydim, profoxydim, haloxyfop, propaquizafop and the C1-4 alkyl and propargyl esters of clodinafop, cyhalofop, diclofop, fenoxaprop, fluazifop, fluazifop-P, haloxyfop, quizalofop, and quizalofop-P (e.g., quizalofop-ethyl, quizalofop-P-ethyl, clodinafop-propargyl, cyhalofop-butyl, diclofop-methyl, fenoxaprop-P-ethyl, fluazifop-P-butyl, haloxyfop-methyl, and haloxyfop-R-methyl). Including one or more of the above additional active ingredients for pest control may provide additional or alternative modes of action to enhance the flexibility and/or comprehensiveness of a weed management strategy. An example weed management strategy may include management of one or more unwanted plants, weeds, or other pests.

In other examples, the phenoxy herbicide or organophosphate herbicide of the agrochemical composition may be selected for use on select crops. As one example, MCPA may be selected as the phenoxy herbicide for use on wheat crops. As another example, 2,4-DB may be selected as the phenoxy herbicide for use on alfalfa crops. While crop-specific herbicides or combinations of herbicides may be known in the art, the use of a substituted morpholine salt of a phenoxy herbicide or organophosphate herbicide may have effects that are unique to a particular crop or target plant.

The composition may demonstrate an adjuvant effect, potentially enhancing the efficacy of the herbicide. For example, the substituted morpholine of a substituted morpholine salts of phenoxy herbicide may promote nitrogen uptake or nitrogen fixation by a selected crop. Examples of NBPT dissolved in substituted morpholines solutions for applications to inhibit urease are described in, for example, U.S. Pat. No. 8,888,886, filed Aug. 6, 2013, entitled “NBPT Solutions for Preparing Urease Inhibited Urea Fertilizers Prepared from N-Substituted Morpholines,” the entirety of which is incorporated by reference herein. Application of the substituted morpholine salt of a phenoxy herbicide may enhance herbicide uptake by the same or similar mechanism as believed to increase nitrogen uptake.

In some implementations, the described agrochemical compositions may further include an agriculturally acceptable adjuvant, carriers, excipients, or additives known to those skilled in the art. These other additives or ingredients may be introduced into the agrochemical compositions to provide or improve certain desired properties or characteristics. Hence, the agrochemical composition may further include one or more additional ingredients including, but not limited to, surfactants, foam-moderating agents, preservatives, anti-microbials, antifreeze agents, solubility-enhancing agents, dispersants, stabilizers, dyes, thickening agents, potentiators, and activators. For example, the agrochemical composition may include a surfactant selected from the group consisting of alkoxylated tertiary etheramines, alkoxylated quaternary etheramines, alkoxylated etheramine oxides, alkoxylated tertiary amines, alkoxylated quaternary amines, alkoxylated polyamines, sulfates, sulfonates, phosphate esters, alkyl polysaccharides, alkoxylated alcohols, and combinations thereof. These or other surfactants may enhance the spreading, wetting, or other surface-modifying properties of the agrochemical composition. The weight ratio of the substituted morpholine salt of phenoxy herbicide to surfactant may be within a range between approximately 1:1 to approximately 20:1, such as between approximately 2:1 to approximately 10:1 or between approximately 3:1 to approximately 8:1.

Unlike some conventional formulations such as quaternary ammonium salts or choline salts, which may cause tank mixing issues with certain compounds, the agrochemical compositions disclosed herein may be compatible with a wide range of other formulation constituents. For example, when exposed to hard water, the herbicide in a choline-based herbicide composition may bind to calcium and magnesium ions, reducing the effectiveness of the herbicide. In contrast, the described substituted morpholine salts of phenoxy herbicides do not experience such negative reactions with hard water. Additional examples of water conditioning agents to counteract the negative effects of hard water are described in U.S. Pat. No. 11,096,389, filed Sep. 16, 2015, entitled “Alkanolamine Sulfate Water Conditioners;” U.S. Pat. No. 9,271,488, filed Sep. 16, 2014, entitled “Isethionic Acid Salts in Field Ready Spray and Tank Mixes;” U.S. Pat. No. 8,883,685, filed Apr. 23, 2010, entitled “Nitrogen Containing Isethionic Acid Salt in Registerable, Stable Agricultural Formulations;” the entirety of each of which is incorporated by reference herein.

The described agrochemical compositions may offer additional advantages over conventional herbicide salt formulations. For example, the agrochemical compositions may provide increased uptake by target plants, reduced volatility, and improved compatibility with other herbicides and formulation components. These properties may contribute to more effective and efficient weed control across a range of agricultural, commercial, and residential applications.

The agrochemical composition may be formulated and prepared through any suitable technique. In some examples, the process may involve forming a salt of a substituted morpholine with a phenoxy herbicide. In some examples, preparation may include combining the phenoxy herbicide in a free acid form with the substituted morpholine under controlled conditions. In some examples, the combining may be carried out in a suitable solvent, such as water or other solvents. For example, 2,4-dichlorophenoxyacetic acid (2,4-D) may be first dissolved in water, followed by the addition of hydroxyethyl morpholine (HEM) to form a salt. Formation of the herbicide salt results from proton exchange between the free acid phenoxy herbicide and the substituted morpholine.

The substituted morpholine component may be prepared by reacting morpholine with an alkylene oxide or ethylene oxide. In some examples, morpholine may be reacted with ethylene oxide to form hydroxyethyl morpholine (HEM). Other suitable alkylene oxides may include, but are not limited to, propylene oxide or butylene oxide.

In some examples, a preparation process may include combining the herbicide salt with an agriculturally acceptable adjuvant or carrier. This step may enhance the performance or application characteristics of the composition. For example, if included, surfactants or other additives may be incorporated before or after combining the phenoxy herbicide with the substituted morpholine.

The final composition may be adjusted to achieve the desired concentration and pH. In some examples, additional water may be added to reach the target volume, and the pH may be adjusted if necessary.

The formulation process may be carried out under various temperature and pressure conditions, depending on the specific requirements of the components and the desired properties of the final product. In some examples, the process may be conducted at room temperature and atmospheric pressure, while in other cases, elevated temperatures or pressures may be employed to facilitate the reaction or mixing process.

The agrochemical composition may comprise specific weight percentages of components. In some examples, the composition may include 2,4-D acid having a weight percent (relative to the total weight of the composition) within a range from approximately 0.5 weight-percent (wt %) to approximately 75 wt %, HEM having a weight percent within a range from approximately 4 wt % to approximately 45 wt %, and the balance (i.e., quantity sufficient) water. In some examples, the composition may include 2,4-D acid having a weight percent within a range from approximately 0.5 weight-percent (wt %) to approximately 75 wt %, HEM having a weight percent within a range from approximately 4 wt % to approximately 45 wt %, without water. A specific example of a composition may include 40 wt % 2,4-D acid, 39 wt % HEM, and 21 wt % water. Another specific example of a composition may include 50 wt % 2,4-D acid, 40 wt % HEM, and 10 wt % water. In some examples, the composition may further include additional components such as surfactants. For example, the composition may include 5 wt % to 20 wt % surfactant in addition to the 2,4-D Acid, HEM, and water.

The agrochemical compositions disclosed herein may be applied in various ways to control pests, particularly weeds, in agricultural settings. In some examples, the composition including a substituted morpholine salt of a phenoxy herbicide may be applied directly to crops or to target plants or other pests. When used as an herbicide, the composition may be applied to the foliage of target plants or weeds using conventional agricultural spraying equipment. In some examples, the composition may be used in the preparation of concentrate, tank mix, or ready-to-use (RTU) formulations or otherwise diluted with water or other suitable carriers before application. Tank mix and RTU formulations, including the described agrochemical composition, may include from about 0.1 grams of analyte per liter (g a.e./L) to about 50 g a.e./L total herbicide loading, while concentrate formulations typically comprise from about 50 to about 750 g a.e./L, from about 300 to about 750 g a.e./L, from about 350 to about 750 g a.e./L, from about 400 to about 750 g a.e./L, from about 450 to about 750 g a.e./L, or even from about 500 to about 750 g a.e./L total herbicide loading (for example, 50, 100, 150, 200, 250, 300, 350, 400, 450, 500, 550, 600, 650, 700, or even 750 g a.e./L, and ranges thereof).

In some examples, an ultra-concentrated formulation may include up to about 920 a.e./L total herbicide loading, or about 70 wt % 2,4-D and 30 wt % HEM. Such ultra-concentrated formulations may be possible because HEM may act as a solvent for 2,4-D in the ultra-concentrated formulation.

In some examples, an ultra-concentrated formulation may include up to about 920 g a.e./L total herbicide loading, or about 70 wt % 2,4-D and 30 wt % HEM. Such ultra-concentrated formulations may be possible because HEM may act as a solvent for 2,4-D in the ultra-concentrated formulation. This dual functionality of HEM as both a neutralizing base and a solvent may enable higher active ingredient loadings compared to conventional formulations that require additional solvents or carriers. For example, the maximum loading of a dimethylamine salt based formulation may be between about 40 wt % and about 55 wt % before crystallization or otherwise instability makes prohibits further loading. The ability to achieve these ultra-concentrated formulations may provide advantages in terms of reduced packaging, transportation costs, and storage requirements, while maintaining the stability and efficacy of the herbicide composition.

The agrochemical composition may be applied to the foliage of an unwanted or target plant at an application rate sufficient to give a commercially acceptable rate of weed control. Commercially acceptable may refer to a level or degree of weed control that provides sufficient efficacy to justify the cost and effort of application in commercial agricultural practice. A commercially acceptable rate of weed control may include weed suppression or elimination that results in measurable benefits to crop yield, quality, or ease of harvest, such that the treatment provides economic value to the grower or land manager.

The application rate may vary depending on factors such as the target plant species, selected crop species, soil conditions, growing conditions, and environmental factors. Typical application rates may range from 0.5 to 3 pounds of active ingredient per acre but may be adjusted as needed. The period of time required to achieve a commercially acceptable rate of weed control can be as short as a week or as long as three weeks, four weeks, or 30 days. The described agrochemical composition can be applied before planting, at planting, pre-emergence, or post-emergence to crop plants depending on the particular herbicide salt and crop plant.

One advantage of the disclosed composition is its potential for continued uptake and reduced volatility during droplet dry down. This property may allow for more effective weed control even under challenging environmental conditions. In some examples, the composition may maintain herbicidal activity for at least 10 days after application, such as at least 28 days after application, providing extended control of target weeds.

As mentioned above, volatility is a known problem of application mixtures containing salts of phenoxy herbicides. The described agrochemical compositions are believed to provide desirable low volatility and reduced associated offsite movement. In some examples, the described agrochemical composition may provide greater than about 20%, 30%, 40%, 50%, 60%, 65%, 75%, 80%, or 85% reduction in volatility compared to commercially available phenoxy herbicide salts. Volatility reduction may be quantified experimentally by methods known in the art. In one method, the volatility of solutions containing an herbicide salt can be measured in the gas phase (air) via tube tests. In a tube test, a sample of the herbicide solution is placed in a test tube that has been modified to allow airflow through the tube. A selective collection medium is attached to the outlet of the tube to collect volatilized herbicide. The collection medium is then analyzed for the respective herbicide. In another method, the volatility of solutions containing an herbicide salt can be evaluated by measuring herbicide concentrations in the gas phase (air) through air sampling in humidome plant growth chambers, which are maintained at constant temperature and humidity.

The composition may be effective across broader geographic regions compared to some conventional herbicide formulations. This broad-spectrum effectiveness may be due to the unique properties of the substituted morpholine salt, which may enhance the stability and activity of the phenoxy herbicide component across various environmental conditions.

The described agrochemical composition may be applied to the foliage of target plants in the proximity of crop plants. Crop plants may include hybrids, inbreds, and transgenic or genetically modified plants with specific traits or combinations of traits including, without limitation, herbicide tolerance (e.g., tolerant to phenoxy herbicides or other herbicides), Bacillus thuringiensis (Bt), high oil content, high lysine levels, high starch content, nutritional density, and drought resistance. Particular crop plants include, for example, corn, peanuts, potatoes, soybeans, canola, alfalfa, sugarcane, sugar beets, peanuts, grain sorghum (milo), field beans, rice, sunflowers, wheat, and cotton. In various embodiments, the crop plant is selected from the group consisting of soybeans, cotton, peanuts, rice, wheat, canola, alfalfa, sugarcane, sorghum, and sunflowers. In other embodiments, the crop plant is selected from the group consisting of corn, soybean, cotton, wheat, and other cereal grains. The composition may also be suitable for use in pastures, rangeland, forestry, and other non-crop areas.

The method of applying the agrochemical composition may involve preparing a spray solution by mixing the composition with water or another suitable carrier. The spray solution may then be applied using ground equipment, aerial application, or other appropriate methods. In some examples, the composition may be tank-mixed with other herbicides or agricultural chemicals to provide broader spectrum weed control or address specific pest management needs.

When applying the composition, factors such as wind speed, temperature, and humidity should be considered to minimize the potential for drift. The unique properties of the substituted morpholine salt may contribute to reduced drift potential compared to some conventional formulations, potentially allowing for more precise application and reduced off-target movement of the herbicide.

In some examples, the composition may be applied as part of an integrated weed management strategy. This approach may involve combining chemical control methods with cultural and biological control strategies to achieve optimal weed management while minimizing environmental impact.

The effectiveness of the composition in controlling weeds may be monitored over time. In some examples, visual assessments of weed control may be conducted at various intervals after application, such as 7, 14, and 21 days after treatment. These assessments may help determine the long-term efficacy of the composition and inform future application strategies.

In some examples, experimental studies may be conducted to evaluate the performance of the agrochemical composition comprising a substituted morpholine salt of a phenoxy herbicide. These studies may compare the efficacy, drift control, and crop safety of the disclosed composition to other herbicide formulations.

### Examples

A field research trial was conducted to evaluate the efficacy of the agrochemical compositions described herein with and without Roundup® PowerMAX® 3. A total of nine treatments were prepared, as indicated in Table 1 below. The treatments included a control without herbicide and eight compositions. The eight compositions included three compositions having only a commercially available 2,4-D based herbicides EnlistOne®, Weedar®, and a 2,4-D Ester; three compositions having the commercially available herbicides and Roundup PowerMAX 3; two compositions including the agrochemical compositions described herein (the “EXP COMP”) with one composition having only EXP COMP and one composition with the EXP COMP and Roundup PowerMAX 3. The EXP COMP included 40 wt % 2,4-D acid, 39 wt % HEM, and 21 wt % water. Each of the 2,4,-D based herbicides, indicated as Herbicide 1 in Table 1, had a concentration of 4 lb a.e./gal, and 49.99 mL was used to provide respective 3 L treatment solution. The Roundup PowerMAX3 indicated as Herbicide 2 in Table 1, had a concentration of 5.88 lb a.e./gal and 34.01 mL was used to provide the respective 3 L treatment solutions. The treatment solutions were applied at a rate of 1 lb a.e./acre. For the field research trial, Roundup Ready® soybeans were used as particle drift barrier rows (4 rows between treatments). Treatments were applied to native weed species and measured against broad leaf signal grass (Brachiaria platyphylla or BRAPP), ivy leaf morning glory (Ipomoea hederacea or IPOSS) at different days after treatment (DAT) of 7 DAT, 13 DAT, and 22 DAT. Results were averaged among 4 replicates (reps) per plot, 36 total plots were used. Treatments were applied in 15 gallons per acre spray volume. Phytotoxicity was monitored in the barrier rows of Roundup Ready soybeans and in the weed control rows with Enlist® soybeans.

TABLE 1
Experimental treatments used in field research test.

| Treatment No. | Herbicide 1 | Herbicide 2 |
|---|---|---|
| 1 | None | None |
| 2 | EXP COMP | Roundup PowerMAX 3 |
| 3 | Enlist One | Roundup PowerMAX 3 |
| 4 | Weedar | Roundup PowerMAX 3 |
| 5 | 2,4-D Ester | Roundup PowerMAX 3 |
| 6 | EXP COMP | None |
| 7 | Enlist One | None |
| 8 | Weedar | None |
| 9 | 2,4-D Ester | None |

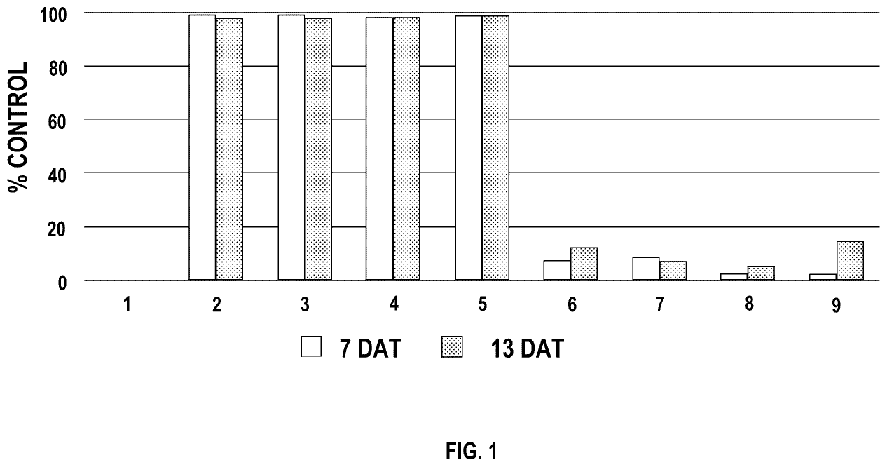

FIG. 1 illustrates the control of broadleaf signal grass (Brachiaria platyphylla or BRAPP) at 7 days after treatment (DAT) and 13 DAT for the experimental treatments. The control (Treatment 1) showed no control of BRAPP. The compositions with Roundup PowerMAX 3 (Treatments 2, 3, 4, and 5) demonstrated nearly 100% control of BRAPP at both 7 DAT and 13 DAT. Compositions without Roundup PowerMAX 3 (Treatments 5, 7, 8, and 9) demonstrated control of less than 20%. Notably, Treatments 6 (EXP COMP) and 9 had the highest control at 13 DAT among the compositions without Roundup Power MAX 3.

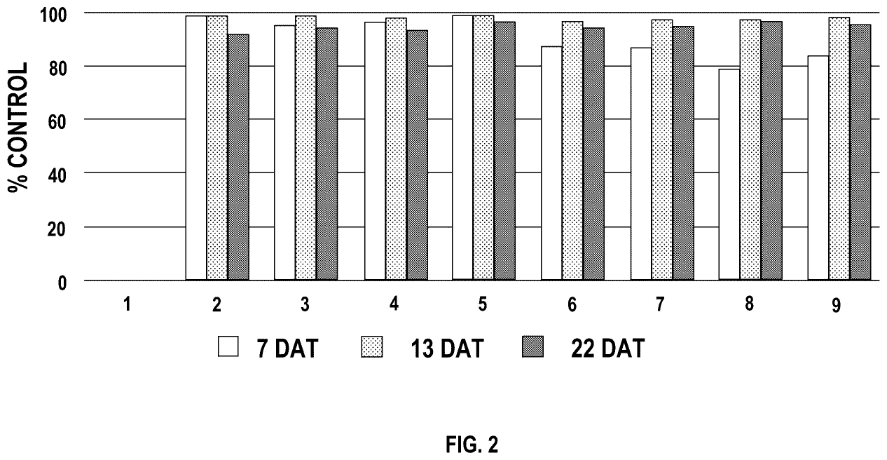

FIG. 2 illustrates the control of ivy leaf morning glory (IPOSS) at 7 DAT, 13 DAT, and 22 DAT for the experimental treatments. The control (Treatment 1) showed no control of IPOSS. The compositions with Roundup PowerMAX 3 (Treatments 2, 3, 4, and 5) demonstrated over 90% control of IPOSS at 7 DAT, 13 DAT, and 22 DAT. Compositions without Roundup PowerMAX 3 (Treatments 6, 7, 8, and 9) demonstrated less control at 7 DAT, but more than 90% control at 13 DAT and 22 DAT. Notably, Treatments 6 (EXP COMP) and 7 had the highest control at 13 DAT among the compositions without Roundup PowerMAX 3. These results illustrate that the compositions with EXP COMP (either with or without Roundup PowerMAX 3) provide excellent control with no significant differentiation relative to commercially available herbicides. The sustained high levels of control across 7, 13, and 22 DAT may indicate the effectiveness and persistence of the EXP COMP.

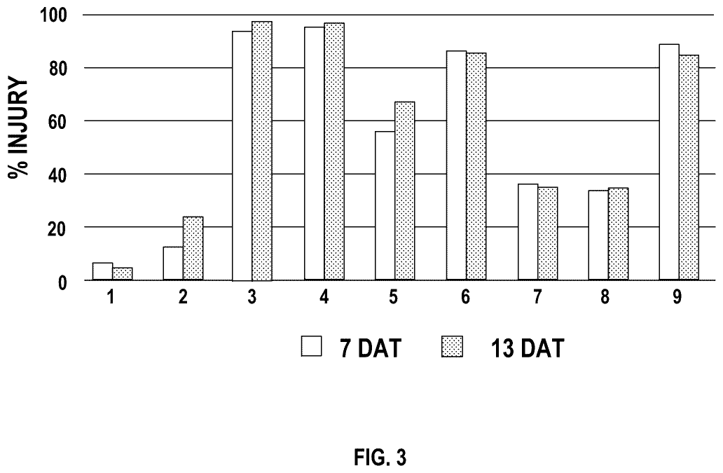

Regarding the analysis of border rows, damage was measured on Roundup Ready Soybeans, looking for apparent 2,4-D symptoms as a percent injury. Border Rows were labeled based on distance from the trial field (i.e., Border Row 1 is closest, and Border Row 4 is farthest away). FIGS. 3 through 6 illustrate the percent injury for each of the Border Rows 1 through 4, which may be indicative of drift potential. Generally, the measurement of particle drift has large variances. The EXP COMP demonstrated this variance when considering Treatment 2 and Treatment 6. Notably, Treatment 6 had no surfactants or drift-reducing agents in the formulation, whereas Treatments 7, 8, and 9 have either surfactants and/or drift-reducing agents (DRAs). Additionally, Roundup PowerMAX 3 (used in Treatments 2, 3, 4, and 5) includes surfactants and DRAs.

FIG. 3 illustrates the percent injury to Border Row 1, the closest to the treatment area. Treatment 2 demonstrated the lowest injury percentage compared to the other treatments, potentially indicating reduced drift. Treatment 6 demonstrated an injury percentage approximately equivalent to Treatment 9; however, this data may be indicative of an outlier relative to particle drift. Notably, Enlist E3® soybeans are resistant to 2,4-D choline, which is the active ingredient in Treatment 7.

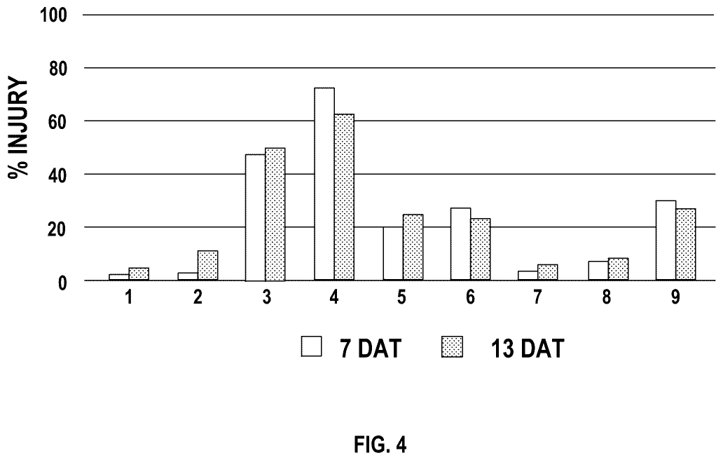

FIG. 4 illustrates the percent injury to Border Row 2, the second closest to the treatment area. Treatment 2 demonstrated the lowest injury percentages compared to the other treatments, potentially indicating reduced drift. Treatment 6 had a lower injury percentage compared to Treatment 9. Notably, injury percentages for Treatments 3 and 4 were much greater than for other treatments.

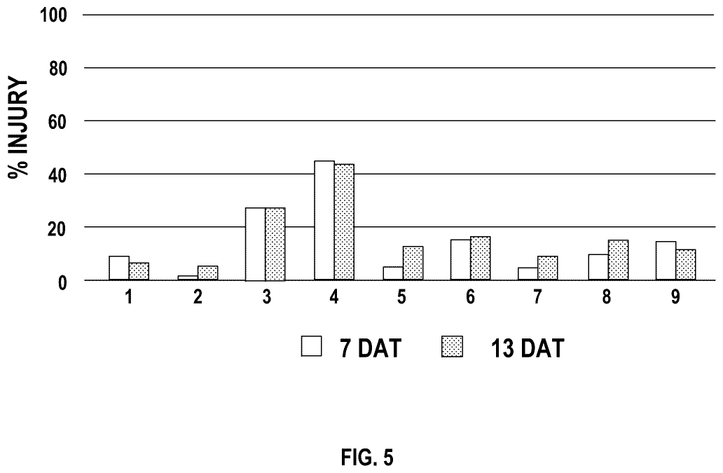

FIG. 5 illustrates the percent injury to Border Row 3, the second farthest from the treatment area. Treatment 2 demonstrated the lowest injury percentages compared to the other treatments, potentially indicating reduced drift. Treatment 6 had an injury percentage comparable to Treatments 7, 8, and 9. Notably, injury percentages for Treatments 3 and 4 were much greater than for other treatments.

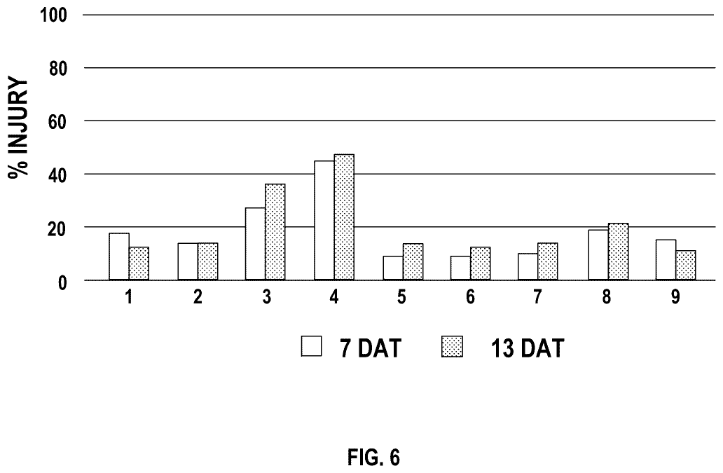

FIG. 6 illustrates the percent injury to Border Row 4, the farthest from the treatment area. Treatment 6 demonstrated the lowest injury percentages compared to the other treatments, potentially indicating reduced drift. Treatment 2 had a lower injury percentage compared to Treatments 3 and 4. Notably, injury percentages for Treatments 3 and 4 were much greater than for other treatments.

The experimental results demonstrate that the agrochemical composition including a substituted morpholine salt of a phenoxy herbicide exhibits high herbicidal effectiveness compared to other commercially available 2,4-D products. This efficacy may be comparable to or better than dimethylamine salt, ester forms, and choline salt of the phenoxy herbicide, as evidenced by the control percentages shown in FIG. 1 and FIG. 2.

The composition may also demonstrate low vapor and/or particle drift potential compared to dimethylamine salt, ester forms, and choline salt of the phenoxy herbicide, particularly in view of no surfactant or DRA being present in the EXP COMP of Treatments 2 or 6. This characteristic may be inferred from the generally lower injury percentages observed in the border row studies (FIG. 3 through FIG. 6) for treatments containing the substituted morpholine salt.

In some examples, the composition may be substantially odorless, which may be an advantage over some conventional formulations that have strong odors.

The composition may demonstrate rain fastness, allowing it to remain effective even after rainfall. While not explicitly shown in the provided figures, this property may contribute to the sustained high control percentages observed over time in FIG. 1 and FIG. 2.

In summary, the experimental results may suggest that the agrochemical composition including a substituted morpholine salt of a phenoxy herbicide demonstrates high herbicidal effectiveness, low vapor and/or particle drift potential, and potentially improved rain fastness compared to dimethylamine salt, ester forms, and choline salt of the phenoxy herbicide. These characteristics make the composition an effective and potentially safer option for weed control in various agricultural applications.

Additional experimental studies were conducted to evaluate pH characteristics and odor properties of the agrochemical compositions described herein.

### pH Titration Study.

A pH titration study was performed to compare the neutralization behavior of 2,4-D with two different amines: diglycolamine (DGA) and hydroxyethyl morpholine (HEM). The study examined how pH changes as a function of the amine to 2,4-D molar ratio. Solutions were prepared by combining 2,4-D acid with varying amounts of DGA or HEM, and pH measurements were recorded at different molar ratios ranging from approximately 0.5 to 2.0.

Table 2 presents the pH titration data for the DGA system and HEM system. For the DGA system, at a molar ratio of 0.50, the pH was measured at 4.42. As the molar ratio increased, the pH rose progressively. This data demonstrates the characteristic sigmoidal curve typical of acid-base titrations, with a notable inflection point occurring near the stoichiometric equivalence point around a molar ratio of 1.0.

TABLE 2
pH titration data for 2,4-D with DGA and HEM.

| Molar Ratio (DGA/2,4-D) | pH | Molar Ratio (HEM/2,4-D) | pH |
|---|---|---|---|
| 0.50 | 4.42 | 0.50 | 4.53 |
| 0.60 | 5.18 | 0.60 | 5.01 |
| 0.70 | 5.69 | 0.70 | 5.36 |
| 0.80 | 6.18 | 0.80 | 5.65 |
| 0.90 | 6.73 | 0.90 | 5.90 |
| 1.00 | 7.48 | 1.00 | 6.13 |
| 1.10 | 8.23 | 1.10 | 6.34 |
| 1.20 | 8.73 | 1.20 | 6.52 |
| 1.30 | 9.00 | 1.30 | 6.67 |
| 1.40 | 9.15 | 1.40 | 6.80 |
| 1.50 | 9.25 | 1.50 | 6.90 |
| 1.60 | 9.31 | 1.60 | 6.98 |
| 1.70 | 9.36 | 1.70 | 7.05 |
| 1.80 | 9.40 | 1.80 | 7.11 |
| 1.90 | 9.43 | 1.90 | 7.15 |
| 2.00 | 9.46 | 2.00 | 7.19 |

For the HEM system, at a molar ratio of 0.50, the pH was measured at 4.53. As the molar ratio increased, the pH rose more gradually compared to the DGA system. This data demonstrates markedly different behavior compared to the DGA system, with the HEM neutralization curve showing a more gradual increase and reaching a significantly lower maximum pH even at high molar ratios.

The pH titration data presented in Table 2 demonstrates that HEM-based formulations can be overbased without reaching excessively high pH levels, which may provide advantages in formulation flexibility and tank mix compatibility. In overbased formulations where the molar ratio of HEM to 2,4-D exceeds 1.0, the HEM system maintains a pH in the range of approximately 6.13 to 7.19, even at molar ratios as high as 2.0. This behavior contrasts significantly with DGA-based systems, which as demonstrated pH levels above 8.6 under similar overbased conditions, with pH values ranging from 8.23 at a 1.10 molar ratio to 9.46 at a 2.0 molar ratio. The ability to overbase HEM formulations while maintaining near-neutral pH may allow HEM to function as both a neutralizing base and a solvent with humectant properties, potentially contributing to improved droplet retention and reduced volatility.

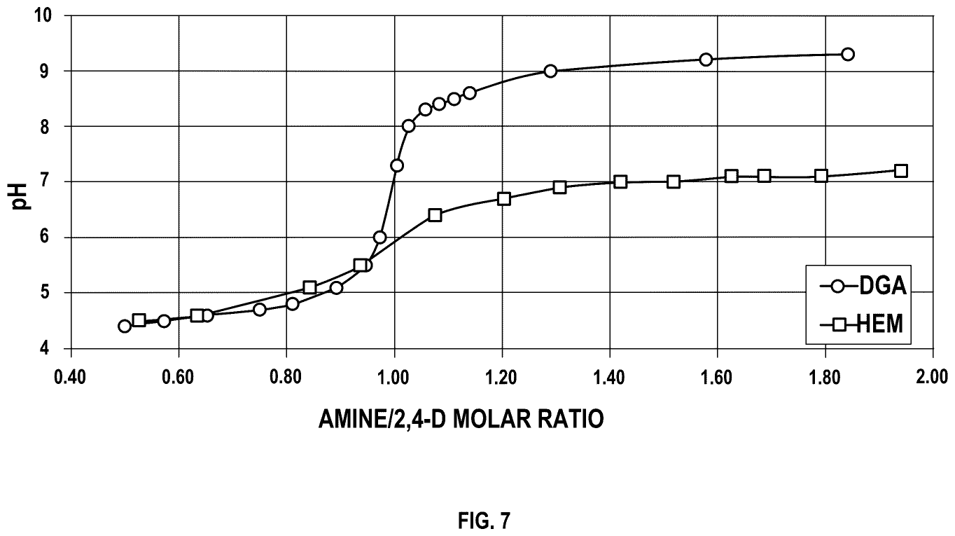

FIG. 7 illustrates the pH titration curves comparing the neutralization behavior of 2,4-D with DGA and HEM as a function of amine to 2,4-D molar ratio. The graph displays pH values on the vertical axis ranging from approximately 4.0 to 10.0, and the amine to 2,4-D molar ratio on the horizontal axis ranging from 0.40 to 2.00. Two distinct curves are shown: a curve for DGA represented by circular data points and a curve for HEM represented by square data points.

The DGA curve demonstrates a characteristic neutralization profile, beginning at a pH of approximately 4.4 at a molar ratio of 0.5 and rising steadily through the neutralization process, eventually plateauing at approximately pH 9.0 to 9.3 at molar ratios above 1.5. In contrast, the HEM curve exhibits markedly different behavior, starting at a similar initial pH of approximately 4.5 at a molar ratio of 0.5 but rising more gradually and reaching a significantly lower maximum pH. Even at molar ratios as high as 1.9 to 2.0, the HEM system maintains a pH of only approximately 7.1 to 7.2, which is substantially lower than the pH achieved by the DGA system at comparable molar ratios.

The divergence between the two curves becomes particularly pronounced at molar ratios above 1.0, where the DGA system continues to increase in pH while the HEM system levels off at a near-neutral pH. This difference of approximately 2 pH units at higher molar ratios may represent a significant distinction in the chemical behavior of these two neutralization systems. The HEM curve's plateau at near-neutral pH values, even with excess base present, may indicate a fundamental difference in the acid-base chemistry compared to the DGA system. This pH behavior may provide advantages in formulation stability and compatibility with other agricultural chemicals. The ability of the HEM system to maintain near-neutral pH even at elevated molar ratios may allow for the use of HEM as both a base and a solvent with humectant properties, potentially contributing to improved droplet retention and reduced volatility.

### Odor Panel Study.

A comprehensive odor evaluation study was conducted to compare the odor profiles of various herbicide salt formulations. The study evaluated four different formulations: dimethylamine (DMA) salt, choline salt, hydroxyethyl morpholine (HEM) salt, and 2-ethylhexyl ester. Five independent subjects (designated A through E) assessed the odor intensity of each formulation under two conditions: neat solution and after spraying application.

The odor intensity was evaluated using a standardized four-point scale: (−) indicating no odor observed, (+) indicating slight odor, (++) indicating noticeable odor, and (+++) indicating strong odor. This methodology provided consistent and reproducible results across multiple evaluators.

Results for neat solutions are illustrated in Table 3 below. The evaluation of neat solutions revealed significant differences among the formulations. The DMA salt consistently produced strong odors (+++), with all five subjects (A, B, C, D, and E) reporting the highest odor intensity level. The 2-ethylhexyl ester similarly exhibited strong odors, with four subjects reporting (+++) and one subject reporting (++) odor intensity.

In contrast, the HEM salt demonstrated remarkably reduced odor characteristics. Four subjects (A, B, D, and E) detected no odor (−) from the neat HEM salt solution, while only one subject (C) reported a slight odor (+). This represents a substantial improvement over both the DMA salt and the 2-ethylhexyl ester formulations.

The choline salt showed intermediate and variable results, with responses ranging from no odor (−) to noticeable odor (++). Two subjects (A and D) reported noticeable odor (++), two subjects (B and E) reported slight odor (+), and one subject (C) detected no odor (−).

TABLE 3
Results for neat solutions.

| SUBJECT | DMA Salt | Choline Salt | HEM salt | 2-ethylhexyl ester |
|---|---|---|---|---|
| A | +++ | ++ | − | +++ |
| B | +++ | + | − | ++ |
| C | +++ | − | + | +++ |
| D | +++ | ++ | − | +++ |
| E | +++ | + | − | +++ |

Results After Spraying are illustrated in Table 4 below. The post-spray evaluation further confirmed the superior odor profile of the HEM salt formulation. All five subjects (A, B, C, D, and E) reported no odor (−) from the HEM salt after spraying application. This complete absence of detectable odor represents a significant advantage for practical herbicide applications.

The DMA salt maintained its strong odor profile after spraying, with all five subjects reporting strong odor (+++). The 2-ethylhexyl ester similarly produced strong odors (+++), with all five subjects detecting the highest odor intensity level after spraying.

The choline salt showed improved odor characteristics after spraying compared to the neat solution, with two subjects (A and C) detecting no odor (−) and three subjects (B, D, and E) reporting slight odor (+). However, the choline salt still exhibited detectable odor in the majority of evaluations, unlike the HEM salt which produced no detectable odor in any post-spray evaluation.

TABLE 4
Results After Spraying.

| SUBJECT | DMA Salt | Choline Salt | HEM salt | 2-ethylhexyl ester |
|---|---|---|---|---|
| A | +++ | − | − | +++ |
| B | +++ | + | − | +++ |
| C | +++ | − | − | +++ |
| D | +++ | + | − | +++ |
| E | +++ | + | − | +++ |

These results demonstrate that the HEM salt formulation provides unexpected and superior odor reduction compared to conventional herbicide salts. As such, the HEM salt formulation is considered substantially odorless both as a neat solution and after application. As used herein, the term “substantially odorless” is defined as having at least 80% of subjects (i.e., evaluators) indicate no odor. The consistent absence of detectable odor from the HEM salt, particularly after spraying application, represents a significant advancement in herbicide formulation technology. This improved odor profile is particularly advantageous for applications in residential, institutional, and commercial settings where odor reduction is critical for user acceptance, neighbor relations, and regulatory compliance.

The strong odors consistently produced by the DMA salt and 2-ethylhexyl ester formulations highlight the limitations of conventional herbicide formulations and underscore the technical advancement provided by the substituted morpholine salts of the present invention. The variable and generally inferior performance of the choline salt further demonstrates that the advantages of the HEM salt are not merely a function of using alternative amine salts, but rather represent a unique and unexpected benefit of the specific substituted morpholine structure.

The following clauses illustrate example subject matter described herein.
Clause 1. An agrochemical composition comprising: a substituted morpholine salt of a phenoxy herbicide, wherein the phenoxy herbicide is an auxin herbicide.
Clause 2. The composition of clause 1, wherein the substituted morpholine is hydroxyethyl morpholine (HEM).
Clause 3. The composition of clause 1 or 2, wherein the substituted morpholine is derived from a reaction of a morpholine and an alkylene oxide or an ethylene oxide.
Clause 4. The composition of any one of clauses 1 through 3, wherein the auxin herbicide comprises at least one of (4-chloro-2-methylphenoxy)acetic acid (MCPA); 2,4-dichlorophenoxyacetic acid (2,4-D); 2,4,5-trichlorophenoxyacetic acid (2,4,5-T); mecoprop; dichlorprop; fenoprop, 4-(2,4-dichlorophenoxy)butyric acid (2,4-DB); 4-(4-chloro-2-methylphenoxy)butyric acid (MCPB); and triclopyr.
Clause 5. The composition of any one of clauses 1 through 4, wherein the substituted morpholine salt of the phenoxy herbicide demonstrates high herbicidal effectiveness and low vapor and/or particle drift potential compared to dimethylamine salt, ester forms, and choline salt of the phenoxy herbicide.
Clause 6. The composition of any one of clauses 1 through 5, further comprising one or more additional active ingredients for pest control.
Clause 7. The composition of any one of clauses 1 through 6, wherein the substituted morpholine provides at least one of increased uptake, improved droplet distribution, reduced volatility, and compatibility with other herbicides and formulation components.
Clause 8. The composition of any one of clauses 1 through 7, wherein the composition is substantially odorless.
Clause 9. The composition of any one of clauses 1 through 8, wherein the composition maintains herbicidal activity for at least 7 days after application.
Clause 10. The composition of any one of clauses 1 through 9, wherein the composition demonstrates rain fastness.
Clause 11. The composition of any one of clauses 1 through 10, further comprising an agriculturally acceptable adjuvant or carrier.
Clause 12. The composition of clause 11, wherein the adjuvant comprises a surfactant.
Clause 13. A method of preparing an agrochemically active composition, comprising: forming a salt of a substituted morpholine with a phenoxy herbicide, wherein the phenoxy herbicide is an auxin herbicide.
Clause 14. The method of clause 13, wherein the substituted morpholine is hydroxyethyl morpholine (HEM).
Clause 15. The method of clause 13 or 14, wherein the method further comprises reacting morpholine with an alkylene oxide or ethylene oxide to form the substituted morpholine.
Clause 16. The method of any one of clauses 13 through 15, wherein the auxin herbicide comprises at least one of (4-chloro-2-methylphenoxy)acetic acid (MCPA); 2,4-dichlorophenoxyacetic acid (2,4-D); 2,4,5-trichlorophenoxyacetic acid (2,4,5-T); mecoprop; dichlorprop; fenoprop; 4-(2,4-dichlorophenoxy)butyric acid (2,4-DB); 4-(4-chloro-2-methylphenoxy)butyric acid (MCPB); and triclopyr.
Clause 17. The method of any one of clauses 13 through 16, further comprising a step of combining the salt with an agriculturally acceptable adjuvant or carrier.
Clause 18. The method of clause 17, wherein the adjuvant comprises a surfactant.
Clause 19. The method of any one of clauses 13 through 16, wherein the composition formed may demonstrate high herbicidal effectiveness and low vapor and/or particle drift potential compared to dimethylamine salt, ester forms, and choline salt of the phenoxy herbicide.
Clause 20. The method of any one of clauses 13 through 17, wherein the composition formed is substantially odorless and demonstrates rain fastness.
Clause 21. A method of controlling pests comprising: applying to a crop or directly to a pest an agrochemical composition comprising a substituted morpholine salt of a phenoxy herbicide, wherein the phenoxy herbicide is an auxin herbicide.
Clause 22. The method of clause 21, wherein the substituted morpholine is hydroxyethyl morpholine (HEM).
Clause 23. The method of clause 21 or 22, wherein the substituted morpholine is derived from the reaction of morpholine with an alkylene oxide or ethylene oxide.
Clause 24. The method of any one of clauses 21 through 23, wherein the auxin herbicide comprises at least one of (4-chloro-2-methylphenoxy)acetic acid (MCPA); 2,4-dichlorophenoxyacetic acid (2,4-D); 2,4,5-trichlorophenoxyacetic acid (2,4,5-T); mecoprop; dichlorprop; fenoprop; 4-(2,4-dichlorophenoxy)butyric acid (2,4-DB); 4-(4-chloro-2-methylphenoxy)butyric acid (MCPB); and triclopyr.
Clause 25. The method of any one of clauses 21 through 24, wherein the composition further comprises one or more additional active ingredients for weed control.
Clause 26. The method of any one of clauses 21 through 25, wherein the composition is applied as an herbicide.
Clause 27. The method of any one of clauses 21 through 26, wherein the substituted morpholine salt of the phenoxy herbicide demonstrates high herbicidal effectiveness and low vapor and/or particle drift potential compared to dimethylamine salt, ester forms, and choline salt of the phenoxy herbicide.
Clause 28. The method of any one of clauses 21 through 27, wherein the substituted morpholine provides increased uptake, reduced volatility, and compatibility with other herbicides and formulation components.
Clause 29. The method of any one of clauses 21 through 28, wherein the substituted morpholine salt of the phenoxy herbicide demonstrate high herbicidal effectiveness, low vapor and/or particle drift potential, and rain fastness compared to dimethylamine salt, ester forms, and choline salt of the phenoxy herbicide.
Clause 30. The method of any one of clauses 21 through 29, wherein the substituted morpholine provides increased uptake, reduced volatility, and compatibility with other herbicides and formulation components.
Clause 31. The method of any one of clauses 21 through 30, wherein the composition further comprises an agriculturally acceptable adjuvant or carrier.
Clause 32. An agrochemical composition comprising the agrochemical composition of any one of claims 1 through 12, wherein the agrochemical composition is substantially odorless, wherein the molar ratio of substituted morpholine salt to auxin herbicide exceeds 1.
Clause 33. The agrochemical composition of clause 32, wherein the pH of the agrochemical composition is at least one of less than about 7.3 or less than about 6.5.

A number of implementations have been described. Nevertheless, it will be understood that various modifications may be made without departing from the spirit and scope of the disclosure. Accordingly, other implementations are within the scope of the following claims.

What is claimed is:

1. An agrochemical composition comprising:
a substituted morpholine salt of a phenoxy herbicide,
wherein the phenoxy herbicide is an auxin herbicide.

2. The agrochemical composition of claim 1, wherein the substituted morpholine salt is hydroxyethyl morpholine (HEM).

3. The agrochemical composition of claim 1, wherein the substituted morpholine salt is derived from a reaction of a morpholine and an alkylene oxide or an ethylene oxide.

4. The agrochemical composition of claim 1, wherein the auxin herbicide comprises at least one of (4-chloro-2-methylphenoxy)acetic acid (MCPA); 2,4-dichlorophenoxyacetic acid (2,4-D); 2,4,5-trichlorophenoxyacetic acid (2,4,5-T); mecoprop; dichlorprop; fenoprop, 4-(2,4-dichlorophenoxy)butyric acid (2,4-DB); 4-(4-chloro-2-methylphenoxy)butyric acid (MCPB); and triclopyr.

5. The agrochemical composition of claim 1, further comprising one or more additional active ingredients for weed control.

6. The agrochemical composition of claim 1, wherein the agrochemical composition is substantially odorless.

7. The agrochemical composition of claim 1, wherein the agrochemical composition maintains herbicidal activity for at least 7 days after application.

8. The agrochemical composition of claim 1, wherein the agrochemical composition demonstrates rain fastness.

9. The agrochemical composition of claim 1, further comprising an agriculturally acceptable adjuvant or carrier.

10. The agrochemical composition of claim 9, wherein the agriculturally acceptable adjuvant comprises a surfactant.

11. A method of preparing an agrochemically active composition, comprising:
forming a salt of a substituted morpholine with a phenoxy herbicide,
wherein the phenoxy herbicide is an auxin herbicide.

12. The method of claim 11, wherein the substituted morpholine is hydroxyethyl morpholine (HEM).

13. The method of claim 11, wherein the method further comprises reacting morpholine with an alkylene oxide to form the substituted morpholine.

14. The method of claim 11, wherein the auxin herbicide comprises at least one of (4-chloro-2-methylphenoxy)acetic acid (MCPA); 2,4-dichlorophenoxyacetic acid (2,4-D); 2,4,5-trichlorophenoxyacetic acid (2,4,5-T); mecoprop; dichlorprop; fenoprop; 4-(2,4-dichlorophenoxy)butyric acid (2,4-DB); 4-(4-chloro-2-methylphenoxy)butyric acid (MCPB); and triclopyr.

15. The method of claim 11, wherein the agrochemically active composition formed is substantially odorless.

16. A method of controlling weeds comprising:
applying to a crop or directly to a weed an agrochemical composition comprising a substituted morpholine salt of a phenoxy herbicide,
wherein the phenoxy herbicide is an auxin herbicide.

17. The method of claim 16, wherein the substituted morpholine salt is hydroxyethyl morpholine (HEM).

18. The method of claim 16, wherein the substituted morpholine salt is derived from a reaction of morpholine with an alkylene oxide.

19. The method of claim 16, wherein the auxin herbicide comprises at least one of (4-chloro-2-methylphenoxy)acetic acid (MCPA); 2,4-dichlorophenoxyacetic acid (2,4-D); 2,4,5-trichlorophenoxyacetic acid (2,4,5-T); mecoprop; dichlorprop; fenoprop; 4-(2,4-dichlorophenoxy)butyric acid (2,4-DB); 4-(4-chloro-2-methylphenoxy)butyric acid (MCPB); and triclopyr.

20. The method of claim 16, wherein, after applying the agrochemical composition, the agrochemical composition is substantially odorless.
